(19) United States
(12) Patent Application Publication
(10) Pub. No.: US 2006/0259171 A1
(43) Pub. Date: Nov. 16, 2006

(54) Computer-assisted method of providing components for elevators, escalators and moving walkways, and corresponding delivery units

(76) Inventor: Pablo Cruz, Zaragoza (ES)

Correspondence Address: BUTZEL LONG;DOCKETING DEPARTMENT, 100 BLOOMFIELD HILLS PARKWAY, SUITE 200, BLOOMFIELD HILLS, MI, 48304, US

(21) Appl. No.: 11/433,281

(22) Filed: May 12, 2006

(30) Foreign Application Priority Data
May 13, 2005 (EP) 05104053.3

(51) Int. Cl. G06F 19/00

(52) U.S. Cl. 700/95; 700/114

(57) ABSTRACT

A delivery unit is created using a corresponding computer-assisted method of providing components of a transport system. The method includes the steps of: providing a parts list; providing associated assembly information; and packing up the components, wherein the components are packed up by packing material with consideration of the assembly information to form delivery units.

### BACKGROUND OF THE INVENTION

The present invention relates to a computer-assisted method of providing components for elevators, escalators and moving walkways, and associated delivery units.

The most diverse sequences come into use in the production, assembly, packing and delivery of systems or system components. Particularly in the case of complicated systems, such as, for example, elevators, escalators or moving walkways designed for the transport of materials and persons, the demands on the qualification of the personnel are particularly high, since on the one hand the systems are quite complex in themselves, but on the other hand particularly high demands also apply to the safety of the personnel during assembly, as well as to the system to be created or erected.

This can be especially problematic when the assembly has to be undertaken by less skilled personnel or under unfavorable outside circumstances.

Moreover, there is also ever increasing pressure to provide and assemble such installations as quickly and economically as possible.

Methods are known in the realm of general process control that enable customer-oriented composition of subassemblies. U.S. patent application publication 2004/0176867 shows, for example, a method in which customer-specific parts required for a commission are ordered, delivered to a collecting point and dispatched from there, together with requisite assembly instructions, to a completion shop. In the completion shop the individual parts are now completed (put together) and delivered as an overall package to the customer.

In this connection it is disadvantageous that all parts connected with an order are supplied together to the completion shop and the employees of the completion shop have to themselves sort out, for example, the parts belonging to a subassembly on the basis of the assembly instructions and bring them into the correct assembly sequence. This is time-consuming.

### SUMMARY OF THE INVENTION

It is accordingly an object of the present invention to propose a computer-assisted method for improving logistics connected with creation of mechanical transport systems whereby the above-described disadvantages are avoided, and which simplifies not only supply by the manufacturer or supplier, but also delivery to the customer and forms a basis for rational and safe assembly, as well as creating a delivery unit with components for a transport system having a designation, which is suitable for carrying out the mentioned method.

By the term “transport system” there is to be understood in the scope of the present description, in particular, elevators for goods and/or persons as well as escalators and moving walkways. By the term “delivery unit” there is to be understood individual components, or several components contained in a package or packet, of a transport system, inclusive of possible packaging material, wherein such a delivery unit does not have to be identical with delivery units defined in terms of bookkeeping.

The transport system consists of many individual components or subassemblies. The components or subassemblies required for a transport system are comprehended in a parts list. The parts list is consequently usually a list of components or subassemblies and the required number thereof for putting together an elevator or an elevator installation or transport system.

The transport system is integrated in a building. The transport system is delivered to the building in individual components or subassemblies and assembled there into the transport system. The building is accordingly the installation location at which the transport system is ultimately assembled. The installation location has different assembly sectors. An assembly sector is a part region of the installation location. An installation location has several assembly sectors. Thus, for example, each level of an elevator forms an assembly sector, or a floor of an elevator shaft, a ceiling of the elevator shaft or a control room, etc., can form an assembly sector.

The assembly of the transport system includes several individual assembly steps. An assembly step represents an individual assembly action within the overall assembly sequence.

The components for a transport system are either produced entirely at one manufacturer or individual components or preassembled subassemblies are produced at different manufacturers. In addition, delivery to the user or to the place of installation can take place in different ways: either each manufacturer delivers its components or subassemblies directly to the construction site or the components and subassemblies are collected at a principal manufacturer and, optionally after partial assembly processes, delivered from there to the user or the installation location. In every case the components are firstly consolidated, i.e. after production identified and prepared with use of the parts list. This includes, for example, checking the serviceability of a component, a provisional or definitive reservation of the component, calling up of the component or combining several components to form subassemblies appropriate to assembly. The parts list ensures and serves for checking that all requisite components are present in the intended number.

The components are subsequently combined into delivery groups in correspondence with their later use, in terms of location and/or time, with consideration of assembly data and are packed into delivery units with use of specific packing material A delivery unit can contain a single assembly packet and in this case the packing material of the delivery unit at the same time forms the packing material of the assembly packet. A delivery unit can also contain more than one assembly packet and in this case additional, to a certain extent internal, packing material can be used for packing the assembly packet. An assembly packet contains components or subassemblies which preferably belong together in the assembly sequence. In the case of packing up the components are partly or completely enclosed by a stiff or flexible, flat packing material, which in the case of need is also particularly well-protected, and/or combined by appropriate elongate packing material and/or filled into suitable receptacles such as cartons, containers and similar. In that case the delivery units are created from the components.

The associating (placing together) and packing up of the components identified by means of the parts list is carried out in this connection with consideration of the predetermined assembly information, i.e. according to specific assembly criteria. Delivery to the correct installation location and in the correct assembly sector is thereby guaranteed and later internal transport at the installation location avoided, and assembly steps in themselves are simplified. The assembly information is provided in accordance with each order and can be created and prepared manually or by means of a computer. The assembly information takes into consideration the form of embodiment of the transport system as well as local conditions of the installation, such as, for example, number and accessibility of floors, assembly areas, building progress, etc. The assembly information is preferably prepared by a computer after this has recorded an order input. The order input typically contains all particulars necessary in order to identify the requisite components and to be able to provide statements about the assembly thereof and the assembly steps. The order input contains the required customer data recorded by the seller on the basis of the customer or architect requirements. The assembly data are predetermined in their basic framework by the elevator builder and are appropriately adapted to the order input and/or to the building progress.

The assembly information embraces information about assembly sectors to which the delivery units and in a given case the assembly packets are to be transported and where they are required for later assembly, and/or about assembly steps which are to be undertaken within a specific assembly sector in specific time sequence, in a given case with consideration of the assembly steps or the assembly state in other assembly sectors of the installation location.

The assembly information is preferably created and prepared with consideration of the conditions in the building, in which the elevator, escalator or moving walkway is to be set up, or at the installation location. The assembly information preferably equally takes into consideration the number of elevators to be installed in a building or a building part.

With consideration of the assembly information an assembly sector identification and/or an assembly step identification is or are then created for each delivery unit.

Each sector identification contains information about the respective assembly sector at an installation location to which the delivery unit is to be transported. The sector identification makes it possible for the personnel responsible at an installation location, for example at a building site, to deliver each delivery unit to the correct assembly sector.

Each assembly step identification contains information about a sequence of the assembly steps. The assembly step identification makes it easy for the personnel responsible to carry out the assembly steps at the installation location or in the assembly sector step-by-step in the correct sequence.

Each delivery unit is provided with the identification or identifications belonging thereto, wherein large and/or heavy delivery units can also be provided with identifications at several places. The identifications are usually mounted on or at the packing material, but they can also be mounted on one of the components themselves if the components are only bundled up to form a package-like delivery unit or in a given case are contained in an open container. In the case of application of the identifications, information of conventional kind can, if required, also be indicated, for example with regard to a position of the delivery unit or an assembly packet to be adhered to, such as “top” or “bottom”, weight details, as well as prohibitions on storing a delivery unit or an assembly packet below another, heavy object or outside a specific temperature or moisture range or in the vicinity of high field strengths.

The mentioned identifications can be indicated in letter and number combinations or cryptically or in pictograms or barcodes, understandable by any expert. The identifications obviously have to be comprehensible or readable and, in fact, with respect to their later use preferably also or only machine-readable. RF tags can also be used as identification.

After creation of the identifications these are applied to the delivery units manually or by machine and, in particular, either at or on the packing material thereof or on the components themselves if parts of the same are open to view.

If a delivery unit contains several assembly packets, then identifications, generally assembly step identifications, can be created for the individual assembly packets and applied directly on or at these.

The finished delivery units provided with the identifications are thereupon delivered by the manufacturer or manufacturers and transported to the installation location. They can also be collected instead of delivered.

At the installation location the delivery units are distributed to the different assembly sectors. This is particularly simple if the delivery units have sector identifications. If the delivery units have only assembly step identifications, then either specific expert knowledge of the personnel and/or separate supplementary particulars, for example on a chart, are required in order to supply the delivery units to the correct assembly sectors. If the delivery units on the basis of sector identifications have arrived in the correct assembly sectors and they have no assembly step identifications, then the sequence of assembly has to be carried out with the help of specific expert knowledge and/or with the help of additional details. Performance of the new method is obviously particularly simple if the delivery units have not only sector identifications, but also assembly step identifications.

Preferably the new method is also extended to the processing of an incoming order. For this purpose prior to consolidation of the components the input of an order for an elevator is received by way of an electronic interface of a computer, wherein the order input comprises information allowing the computer to determine which elevator type has been ordered and is to be delivered.

The new method preferably comprises a method step in which with computer assistance a list of components of a system to be delivered is prepared and/or a method step in which this list is displayed, for example on a monitor of the computer and/or in a print-out.

It is possible to incorporate in the method an internal transport system by which the individual components are brought from their storage stations to a preassembly or dispatch station.

The identifications can be created in various ways, but it is particularly advantageous and recommended, for avoidance of or reduction in the possibility of human errors, to create the identifications in computer-assisted manner.

For simplification of assembly, certain components can, within the scope of the consolidation, be unified by preassembly at the manufacturer or at one of the manufacturers to form subassemblies, thus preassembled. For this purpose, prior to packing up, information relating to optimized preassembly of at least a part of the components or at least a subassembly can be used and preferably called up, and this subassembly can be assembled. In the case of packing up not only the individual components, but also the components preassembled to form subassemblies are then packed.

It has proved to be time-saving if after input or processing of an order it is checked with the help of a computer whether all components are present, able to be produced in the short term or able to be immediately called up from sub-suppliers. These steps are regarded as part of the working steps denoted as consolidation. In this manner the sequences of stock-keeping of components and consolidation of the components from input of an order are linked.

In order to avoid damage and losses of individual components, or components preassembled to form subassemblies, at the installation location or in the assembly sectors it is advantageous to remove the components from the packing material only after arrival in the assembly sectors and with consideration of the assembly step identifications thereof and directly before their use.

The identifications should preferably be designed so that they are not only directly readable by a person, but also machine-readable or mechanically detectable with the help of reading apparatus.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is a schematic view of an assembled transport system in the form of an elevator;

FIG. 2 is block diagram the principle of the present invention;

FIG. 3 is a schematic perspective view of components for the transport system illustrated in FIG. 1, wherein in each instance one or more components are contained in a delivery unit;

FIG. 4 is an example for the identifications to be applied to one of the delivery units; and

FIGS. 5A and 5B are flow diagrams showing the sequence of the method according to the present invention.

### DESCRIPTION OF THE PREFERRED EMBODIMENT

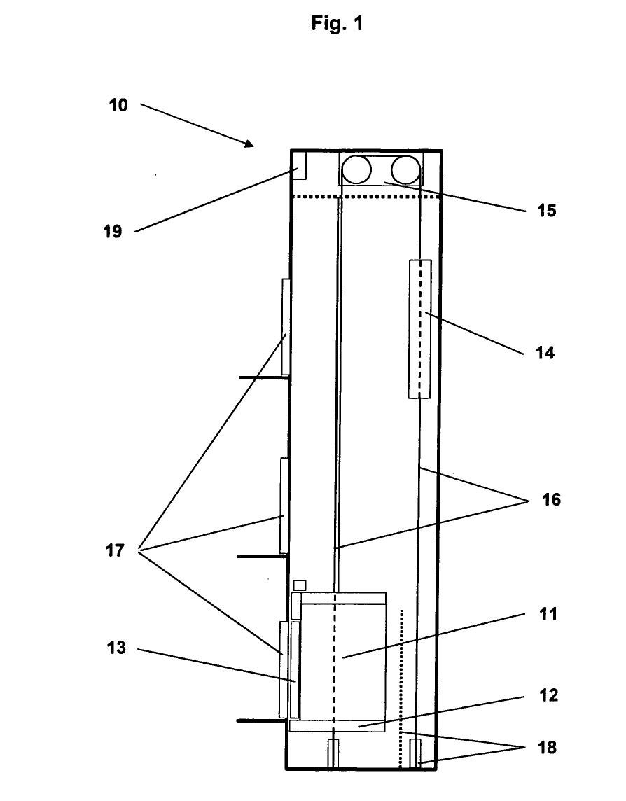

An elevator is illustrated in FIG. 1 as a transport system 10 and substantially comprises the following: an elevator car 11 with a floor forming a load carrier 12, a car door system 13, a counterweight 14, a drive system 15, guide rails 16 for the elevator car 11 or the counterweight 14, shaft doors 17, a control system 19 and shaft material 18. FIG. 1 shows clearly that the overall assembly of the transport system 10 is substantially more complicated than the assembly of a machine, particularly because the individual components are needed in different assembly sectors or on different floors, wherein either no elevator installation for transporting the components to the appropriate floors is present or the individual components are too bulky for such an elevator installation. The overall assembly is further complicated by the fact that in the interests of short assembly time often several elevators of a building are assembled simultaneously and that individual assembly steps have to be carried out in a precise sequence in time on the one hand for functional reasons and on the other hand for safety reasons.

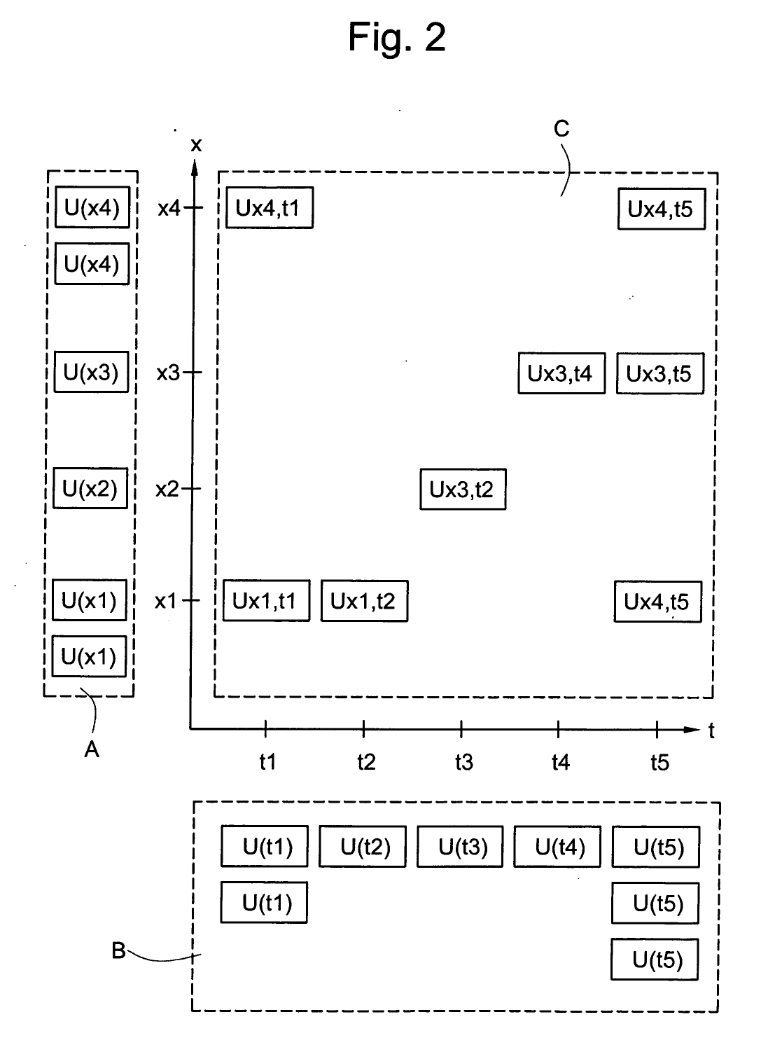

FIG. 2 clarifies the basic concept according to the present invention and three variants A, B, C of the present invention.

A local axis x is indicated in FIG. 2 the vertical direction. The local axis x is not to be understood as a true-to-scale representation of length. In the case of elevators the local axis x can substantially correspond with the actual vertical axis of the construction. In the case of inclined or horizontal transport means or in the case of use of several elevators arranged in the same part of the building the local axis x thereagainst generally corresponds with an assembly sector lying in the vicinity of a specific place, wherein in the present example four assembly sectors x1, x2, x3 and x4 are indicated. One or more delivery units U is or are associated with each of the assembly sectors x1, x2, x3 and x4. The delivery units U are indexed by the designations of the respective assembly sectors to which they are to be transported. The components of the delivery units Ux1 to Ux4 are required in the case of assembly in the assembly sectors x1 to x4.

In FIG. 2 there is additionally indicated in the horizontal direction a time axis t on which the sequence of assembly steps is apparent. The time axis t or the assembly step illustrated therealong are not to be understood as being to scale. In the present example, five assembly steps t1, t2, t3, t4 and t5 are shown and one or more of the delivery units U are provided for each assembly step. The delivery units U are indexed by the designations of the respective assembly steps, for the performance of which they are intended. The components of the delivery units Utl are used for carrying out the assembly step t1 and correspondingly the components of the delivery units Ut2 to Ut5 are needed for carrying out the respective assembly steps t2 to t5.

The three variants A, B and C are possible, as explained above, for carrying out the new method.

In the variant A the delivery units U have sector identifications K(x), whereby it is possible to transport each delivery unit U to the correct assembly sector. For carrying out the assembly steps expert knowledge and/or additional assembly information, in a given case in combination with the sector identification K(x), is or are required.

In the variant B the delivery units U have only assembly step identifications K(t), whereby it is possible to remove the components from the delivery units U in accordance with the respective assembly steps. Expert knowledge and/or additional assembly information, in a given case in combination with the assembly step identifications, is required for delivering the delivery units U to the correct assembly sectors.

In the variant C, which can be termed optimal, the delivery units U have not only sector identifications K(x), but also assembly step identifications K(t) so that the advantages of the variants A and B are used in combination. The delivery units U for the variant C are indexed in FIG. 2 by the designations of the respective assembly sectors or the respective assembly steps. If several elevators of the building parts are to be installed in the same time segment the identifications are preferably oriented towards optimization of the overall installation. Thus, for example, the counterweights 14 of several elevators can be mounted in a specific assembly section which can contain several successive assembly steps.

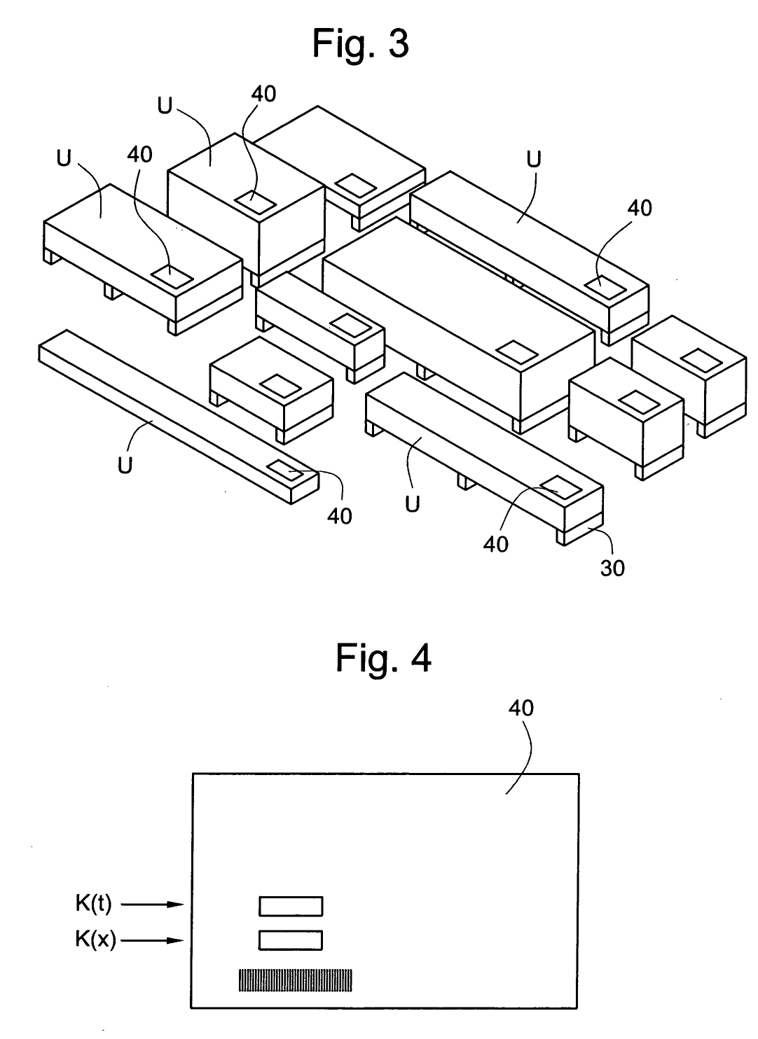

FIG. 3 shows the delivery units U in which the components for the transport system 10, in the present case for the elevator illustrated in FIG. 1, are contained. The components are, after they have been consolidated, packed up by a specific suitable packing material to form the delivery units U. The delivery units U in the present example are, as is frequently the case, arranged on pallets 30 or include the pallets 30.

Useful as packing material are, for example, paper, plastics films, cardboard, wood and polystyrene, by which the components are entirely or partly enclosed, in addition tapes, lines, wires and similar in order to keep the components together with or without enclosing packing material. It is essential that each delivery unit is provided with at least one of the identifications K(x) and/or K(t).

The delivery units U can also include specific tools or checking apparatus, particularly special tools and special checking apparatus which are required only for assembly of components disposed in the respective delivery units.

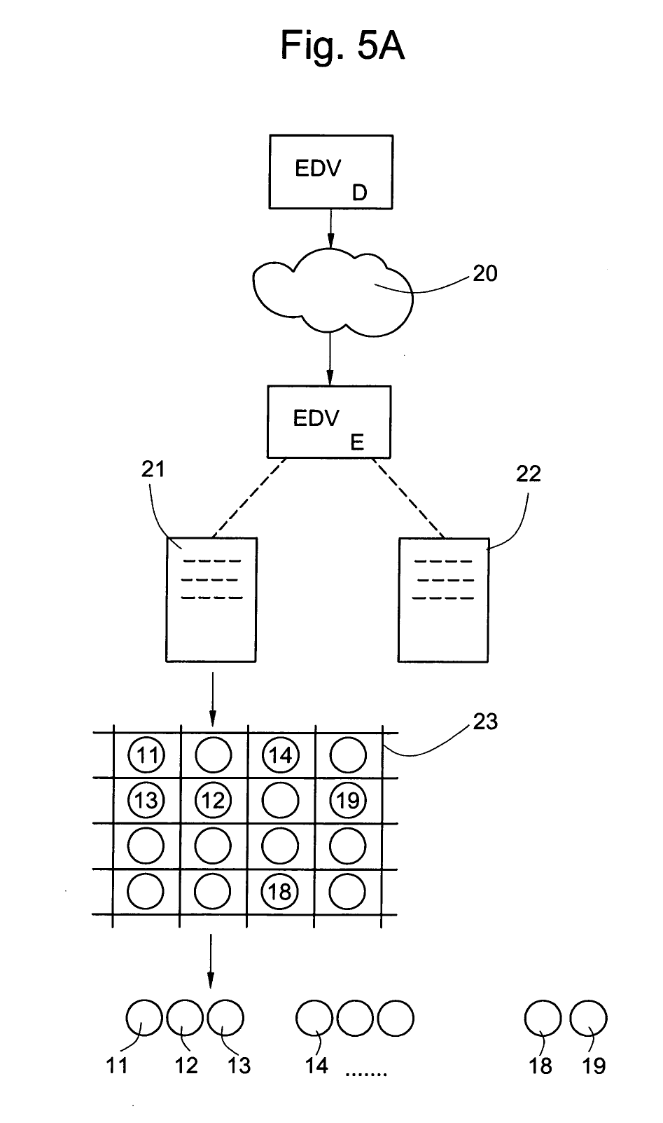

FIG. 4 shows a label 40 on which, in the present example, the identifications K(x), K(t) are applied. The identifications K(x) and K(t) can, however, also be applied directly to the packing material or in a given case to the components themselves. The identification K(x) and the identification K(t) can be applied to the same label or in the same designation field of an item of packing material or of a component, or a separate label or separate designation field can be provided for each identification. In the case of a common label or a common designation field, separate identification fields are provided for the identifications K(x) and K(t).

The labels or designation fields can also contain additional fields in which additional details can be entered. Moreover, the labels can contain empty fields which, for example, can be used in connection with checks relating to stock-keeping, delivery or book-keeping.

The identifications K(x), K(t) can be designed in the most diverse ways. They have to be comprehensible or readable, preferably also—or only—machine-readable. Letter combinations and numeral combinations in plain text or with cryptic details and abbreviations, pictorial illustrations, particularly those like pictograms, barcodes, especially come into question. In addition, the inclusion of differently colored identifications or the use of RF tags is possible.

The identifications K(x), K(t) can be mounted or applied by gluing, welding, printing or impressing at the labels 40 or directly at packing material or the components of the delivery units U.

The delivery unit U contains, as mentioned, one of the components 11 to 19 or several of the components. In a given case, at least a part of the components 11 to 19 can be pre-packed to form at least one assembly unit contained in the delivery unit U or an assembly packet.

The identifications K(x), K(t) applied to the delivery unit are readable, preferably machine-readable. The identifications K(x), K(t) are preferably formed in such a way that they are not only readable by a person, but also machine-readable by a reading apparatus.

It is particularly advantageous for a trouble-free sequence of assembly if the identifications K(t) comprise a reference to an assembly instruction of if, through reading in the identifications by means of reading apparatus, information for the approaching assembly step is illustrated on a picture screen or a print-out.

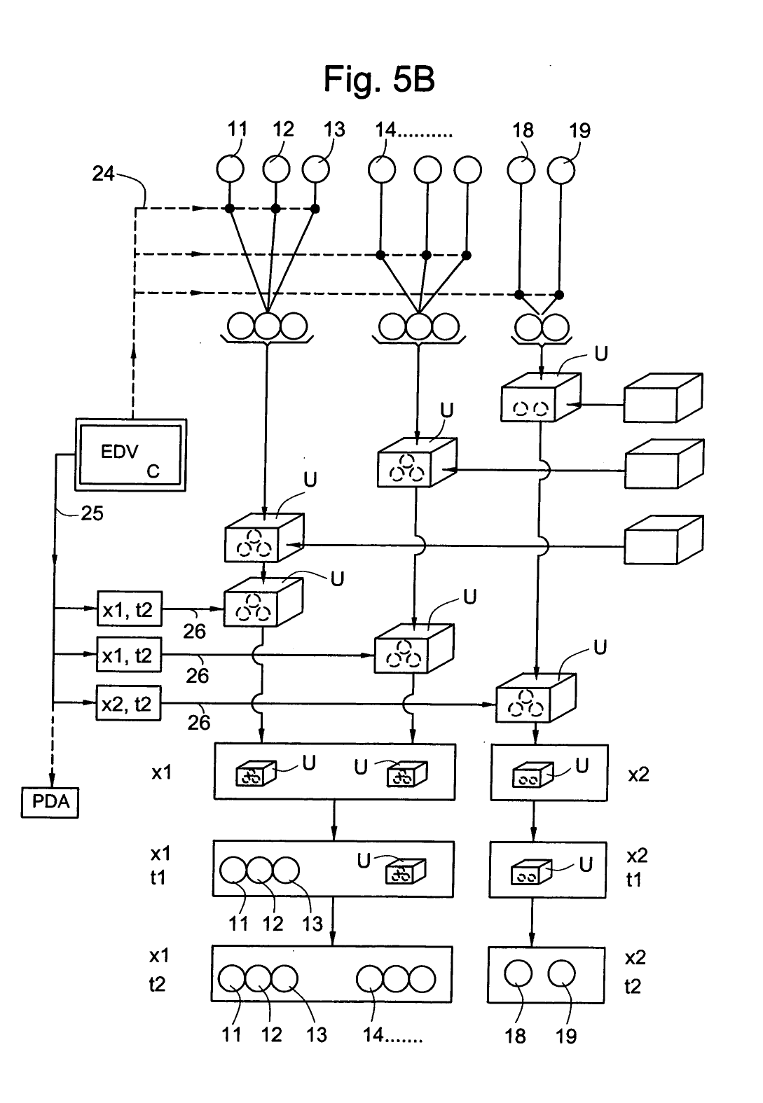

FIGS. 5A and 5B show the sequence of the new method in a diagram, with the following steps:

A system to be ordered is defined or configured by means of a computer D. This step is optional. It can, for example, be carried out by an architect planning a new building or it can concern conversion or demounting of an existing system. This customer wish is established directly in the order input by the seller or by the customer.

After this step is concluded, an order EDV can be communicated, for example in the form of a standardized EDI (electronic data interchange) order, or in a different way to the producer of the system. In FIG. 5A, there is shown an example in which this communication takes place to a computer E by way of a network 20. These steps can also, as indicated, be worked down on a conventional route, for example by formulae.

A parts list 21 and associated assembly information 22 can then be prepared by means of the computer E. This takes place, in a particularly preferred method, in that all necessary parameters and other particulars are extracted from the incoming information EDV (order) or information input into a computer. The parts list 21 and/or the assembly information 21 is or are then determined on the basis of these parameters and particulars. In that case, apart from pure management parameters and details use is made, for the purpose of the invention, of principal technical magnitudes, such as, for example: the number of elevators of a building part, kind of drive, useful load, number of persons, nominal speed, number of stops, number of entrances, position of entrances; engine room above, below or no engine room, kind of cable guide, shaft plan and elevation, stopping point distance, car type, etc. The parts list is usually a list of components or subassemblies and the required number thereof in order to put together an elevator or an elevator installation. It contains, for example, a designation or identification of the components, as well as a piece list which, for example, indicates how many guide rails of 2.5 m or 5 m length are required, to give only one example.

The assembly information 22 comprises details about the assembly sectors x1 to x4 and/or the assembly steps t1 to t5. Preferably the computer E accesses a database and/or knowledge base in order to be able to provide and appropriately adapt these particulars. For provision of the assembly information 22 and the parts list 21 use is preferably made of details able to be inferred from the commission input or order input. The database and/or knowledge base contains or contain, for example, a basic framework predetermined by the elevator builder, which is appropriately adapted in correspondence with the customer wish documented in the order input.

It may be noted that neither the parts list 21 nor the assembly information 22 need be present in paper form. There can be other forms of reproduction or provision of information.

The constituents 11 to 19 of the system 10 to be provided are initially consolidated. This step is schematically indicated in the lower part of FIG. 5A. The components needed for the system are identified on the basis of the parts list 21. It is then checked whether the components are in store (the store is indicated in FIG. 5A in the form of a shelving store 23) or whether the components are to be supplied by suppliers. As soon as all components are present, these are prepared. This preparation does not have to mean that the components are removed from storage. The preparation can be a logical preparation. This is indicated in FIG. 5A at the bottom, in which the components 11 to 19 were arranged in a row.

A computer C (it can be identical with the computer E or linked therewith) prepares assembly information. In FIG. 5B this is indicated by a multiple arrow 24. The assembly information itself is indicated as a function f of the magnitudes x1, t1, etc.

In accordance with the assembly information the components 11 to 19 identified by way of the parts list 21 are combined into delivery groups, wherein in that case the assembly sectors and the assembly steps are taken into consideration. The consolidation phase is concluded by this step.

The delivery groups are subsequently provided with suitable packing material and a delivery unit U results from each group. These delivery units are shown simplified in the form of square boxes in FIG. 5B.

The sector identification K(x) and/or the assembly step identification K(t) is or are then similarly generated or prepared for each delivery unit with information of the computer C. This process is indicated in FIG. 5B by an arrow 25. These identifications K(x), K(t) are applied to the delivery units U as indicated by an arrow 26. The thus-identified delivery units U are now provided. They can then be collected, stored or delivered.

The thus-identified delivery units U are consecutively or later brought to the installation location and there, on the basis of the sector identifications K(x), to the assembly sectors x1, x2. The components can be removed from the packing material in accordance with the assembly step identifications K(t).

The last two steps are optional. They are schematically indicated in FIG. 5B in the lower part of the drawing.

A further optional step is indicated in FIG. 5B. The assembly information or other information can be communicated by the computer C to the assembly personnel. This can take place, for example, in that the information is re-recorded on a portable computer (PDA).

It is obvious that the described method can be modified and the respective details adapted. Depending on the respective degree of automation of the sequences a greater or lesser number of steps of the method can run down in computer-assisted manner. A computer or a number of linked computers can be used.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A computer-assisted method of providing components of a transport comprising the steps of:
a. providing a parts list containing definitions of components required for a specific transport system and a number of the components;
b. providing assembly information including details about at least one of assembly sectors and assembly steps of the specific transport system;
c. identifying and providing the components in accordance with the parts list; and
d. combining the components with use of the assembly information to form delivery groups, wherein the delivery groups are packed up by packing material to form delivery units.

2. The method according to claim 1 wherein at least a part of the components to be provided are consolidated with use of at least one of the parts list and the assembly information.

3. The method according to claim 1 including providing the delivery units with at least one of sector identifications and sequence identifications which are readable, preferably machine-readable, wherein the identifications comprise, in correspondence with the items of assembly information, information about at least one of the respective assembly sectors at an installation location to which the delivery unit is to be transported and a sequence of assembly steps making it possible for personnel to perform the assembly steps step-by-step at the installation location.

4. The method according to claim 3 including creating or processing the identifications with a computer.

5. The method according to claim 3 including performing at least one of the steps of: manual or mechanical application of the identifications to the delivery units; transporting the delivery units to the installation location; and distributing the delivery units to the different assembly sectors in the region of the installation location on the basis of the identifications.

6. The method according to claim 3 wherein the sector identifications are present and the delivery units are transported on the basis of the sector identifications to the assembly sectors at the installation location and the components are removed on site from the packing material only after arrival in the assembly sectors.

7. The method according to claim 3 wherein the sequence identifications are present and the components are removed from the packing material on site only after arrival in the assembly sectors and in accordance with the sequence identifications.

8. The method according to claim 3 wherein the identifications are readable by a person and are machine-readable by a reading apparatus.

9. The method according to claim 1 including a step of receiving an order for the specific transport system electronically, wherein an input of the order includes information enabling a computer to provide at least one of the parts list and the assembly information in said step a.

10. The method according to claim 1 including at least one of the steps of: providing the parts list and/or the assembly information by a computer; and displaying the parts list and/or the assembly information on a screen or print-out of the computer.

11. The method according to claim 1 including prior to packing up the delivery groups performing the steps of: calling up information for optimized pre-assembly of at least a part of the components; and pre-assembly of this part of the components, wherein subsequently during the packing up the pre-assembled components are packed up.

12. The method according to claim 1 including in case of consolidation checking by a computer whether all required ones of the components are available.

13. A delivery unit having components for a transport system and wherein the delivery unit has a designation comprising:
several components that are required for at least one of a specific assembly step and/or are used in a specific assembly sector; and
a designation containing at least one of a sector identification and a sequence identification, said sector identification having information about the specific assembly sector of an installation location to which the delivery unit is to be transported and the sequence identification having information about an assembly step during which the components of the delivery unit are to be used so as to enable assembly personnel to carry out the assembly steps step-by-step at the installation location.

14. The delivery unit according to claim 13 wherein at least a part of the components are packed up to form at least one assembly packet contained in the delivery unit.

15. The delivery unit according to claim 13 wherein the identifications are readable by at least one of a person and a reading apparatus.

16. The delivery unit according to claim 13 wherein the identifications are mounted on or applied to packing material or the components of the delivery unit by at least one of gluing, welding, printing or impressing.

17. The delivery unit according to claim 13 wherein the identifications reference an assembly instruction.
